(19) United States
(12) Patent Application Publication
(10) Pub. No.: US 2014/0331146 A1
(43) Pub. Date: Nov. 6, 2014

(54) USER INTERFACE APPARATUS AND ASSOCIATED METHODS

(71) Applicant: NOKIA CORPORATION, Espoo (FI)

(72) Inventors: Sami Ronkainen, Tampere (FI); Urho Konttori, Helsinki (FI); Kate Freebairn, Helsinki (FI); Martin Jansky, Espoo (FI); Daniel Gratiot, London (GB)

(73) Assignee: Nokia Corporation, Espoo (FI)

(21) Appl. No.: 13/875,805

(22) Filed: May 2, 2013

(51) Int. Cl. G06F 3/0482; G06F 3/0484

(52) U.S. Cl. CPC G06F 3/0482; G06F 3/04842
USPC 715/741; 715/810

(57) ABSTRACT

An apparatus comprising:
at least one processor; and
at least one memory including computer program code,
the at least one memory and the computer program code configured to, with the at least one processor, cause the apparatus to perform at least the following:
according to a particular determined volume characteristic of at least one stylus within a detection range of a user interface for an electronic device, enable the selection of a particular function of the electronic device selectable using the user interface, the particular function corresponding to the particular determined volumetric characteristic.

### TECHNICAL FIELD

The present disclosure relates to the field of user interfaces configured to enable functionality based on volume determinations, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is common for electronic devices to provide a user interface (e.g. a graphical user interface). A user interface may enable a user to interact with an electronic device, for example, to open applications using application icons, enter commands, to select menu items from a menu, or to enter characters using a virtual keypad.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus comprising:
at least one processor; and
at least one memory including computer program code,
the at least one memory and the computer program code configured to, with the at least one processor, cause the apparatus to perform at least the following:
according to a particular determined volume characteristic of at least one stylus within a detection range of a user interface for an electronic device, enable the selection of a particular function of the electronic device selectable using the user interface, the particular function corresponding to the particular determined volumetric characteristic.

The apparatus may be configured to enable the determination of the volume characteristic.

The volumetric characteristic may be one or more of the volumetric shape, volumetric size (e.g. measured in mm³, such as between 1000 and 2500 mm³), or changes in the volumetric shape and volumetric size of the at least one stylus within the detection range. The changes in size may be relative changes in size (e.g. the change in size expressed as a proportion of the initial sizes, such as a relative increase or decrease of between 10 and 30%) or absolute changes in size (e.g. the change in size expressed as a absolute value, such as an absolute increase or decrease of between 500 and 1000 mm³).

The volumetric characteristic may be determined using sensors. The sensors may have an accuracy of, for example, 0.01 mm for distance measurements (e.g. an accuracy of between 0.001 and 0.1 mm). The sensors may have an accuracy of, for example, 1 mm³ for volumetric measurements (e.g. an accuracy of between 0.1 mm³ and 10 mm³).

The detection range may, for example, up to 5 cm above and/or up to 1 cm outside the (outer) surface of the user interface (e.g. a touch screen or touchpad user interface).

The particular function may comprise opening an application in a particular application operating mode of a plurality of application operating modes associated with the application.

The particular function may comprise enabling a particular device operating mode of a plurality of device operating modes associated with the electronic device.

A said application operating mode may be a background application operating mode, a safe application operating mode, an edit application operating mode, a sleep application operating mode (e.g. wherein the functionality of an application is limited and/or the computer resources devoted to the application is restricted), a parent mode, a child mode (e.g. wherein a web browsing application restricts/prevents the presentation of adult content), an adult mode, a read-only application operating mode (e.g. wherein the user is allowed to view emails of an email application but not to edit or send emails), a user-defined application operating mode, or a user-specific application operating mode.

A said device operating mode may be a background device operating mode, a safe device operating mode, an edit device operating mode, a sleep device operating mode, a parent mode, a child mode, an adult mode, a read-only device operating mode, a user-defined device operating mode, or a user-specific device operating mode.

The particular function may be associated with actuation of a particular user interface element (e.g. a particular icon or key) of the user interface.

The particular function may be associated with actuation of the user interface per se (for example, interacting with a home screen per se or simply interacting with a touchpad across its entire surface).

The selection of the particular function may be enabled based on further considering one or more of:
angle of the a said stylus;
velocity of the a said stylus;
the trajectory of the a said stylus;
speed of the a said stylus;
acceleration of the a said stylus;
a user interface element associated with a stylus position; and
a detected gesture input provided using the a said stylus.

A said user input may comprise a combination of one or more of:
a non-touch gesture;
a multi-touch gesture;
a tap gesture;
a drag gesture;
a scroll input;
a three dimensional pattern gesture;
a two dimensional pattern gesture;
a key press; and
a button press.

A volume characteristic may be associated with a particular user, the enabled function being associated with the particular user. That is, the apparatus/device may be configured to recognise a particular user based on the determined volumetric characteristic.

The volume characteristic may be configured to provide authentication information, the authentication information configured to enable the device to authenticate a particular user such that the particular user is allowed to access particular functions specific to the particular user (e.g. functions which are associated with the particular user). For example, the authentication information may be used to enable functionality of the apparatus/device (e.g. to unlock the device, enable a payment to be made).

The volume characteristic may be associated with an age category, the enabled function corresponding to the age category.

The volume characteristic may be associated with a stylus type, the enabled function corresponding to the stylus type. A said stylus type may comprise: a finger; a gloved finger; a hand; a gloved hand; a stylus tool; a pen; a pencil; a mechanical stylus; a substantially tubular object; and a substantially cylindrical object.

The volume characteristic may be determined prior to the at least one stylus touching the user interface; and the selection of a particular function may be performed in response to a touch input provided by the at least one stylus touching the user interface.

The user interface may comprise a combination of one or more of a touchpad, and a touch-screen.

The apparatus may be the electronic device, a portable electronic device, a laptop computer, a desktop computer, a mobile phone, a Smartphone, a monitor, a personal digital assistant or a digital camera, or a module for the same.

The apparatus may be, or form part of, the user interface.

The electronic device may be a portable electronic device, a laptop computer, a desktop computer, a mobile phone, a Smartphone, a monitor, a personal digital assistant or a digital camera, or a module for the same.

In a further aspect, there is provided a method, the method comprising:
according to a particular determined volume characteristic of at least one stylus within a detection range of a user interface for an electronic device, enabling the selection of a particular function of the electronic device selectable using the user interface, the particular function corresponding to the particular determined volumetric characteristic.

In a further aspect, there is provided a computer program, the computer program comprising code configured to:
according to a particular determined volume characteristic of at least one stylus within a detection range of a user interface for an electronic device, enable the selection of a particular function of the electronic device selectable using the user interface, the particular function corresponding to the particular determined volumetric characteristic.

The computer program may be stored on a storage media (e.g. on a CD, a DVD, a memory stick or other non-transitory medium). The computer program may be configured to run on a device or apparatus as an application. An application may be run by a device or apparatus via an operating system.

In a further aspect, there is provided an apparatus, the apparatus comprising:
means for enabling, according to a particular determined volume characteristic of at least one stylus within a detection range of a user interface for an electronic device, the selection of a particular function of the electronic device selectable using the user interface, the particular function corresponding to the particular determined volumetric characteristic.

In a further aspect, there is provided an apparatus, the apparatus comprising:
an enabler configured to enable, according to the particular determined volume characteristic of at least one stylus within a detection range of a user interface for an electronic device, the selection of a particular function of the electronic device selectable using the user interface, the particular function corresponding to the particular determined volumetric characteristic.

The present disclosure includes one or more corresponding aspects, embodiments or features in isolation or in various combinations whether or not specifically stated (including claimed) in that combination or in isolation. Corresponding means and corresponding function units (e.g. first enabler, second enabler) for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts an example embodiment comprising a number of electronic components, including memory and a processor.

FIG. 2 depicts an example embodiment comprising a number of electronic components, including memory, a processor and a communication unit.

FIG. 3 depicts an example embodiment comprising a number of electronic components, including memory, a processor and a communication unit.

FIGS. 4a-4d each depict a front and overhead view of an example embodiment wherein the keyboard provided is dependent on the determined volumetric characteristic of the at least one stylus.

FIGS. 5a-5d depict a further example embodiment wherein the mode of the device is dependent on the determined volumetric characteristic of the at least one stylus.

FIGS. 6a-6c depict the example embodiment wherein the function of a particular user interface element is dependent on the determined volumetric characteristic of the at least one stylus.

FIGS. 7a-7b illustrate an example apparatus in communication with a remote server/cloud.

FIG. 8 illustrates a flowchart according to an example method of the present disclosure.

FIG. 9 illustrates schematically a computer readable medium providing a program.

### DESCRIPTION OF EXAMPLE ASPECTS/EMBODIMENTS

It is common for an electronic device to have a user interface (which may or may not be graphically based) to allow a user to interact with the device to enter and/or interact with information. For example, the user may use a user interface to compose a text message, draw a picture or access a web site. It is not uncommon for the user to provide input to the user interface using a stylus (e.g. a mechanical stylus or finger).

It may be advantageous to tailor the functionality of the device to the particular stylus being used. For example, when using a large stylus, user interface elements may be commensurately large to enable unambiguous interaction with the user interface using the large stylus.

Example embodiments contained herein may be considered to enable selection of a particular function of an electronic device based on a particular determined volume characteristic of a stylus.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

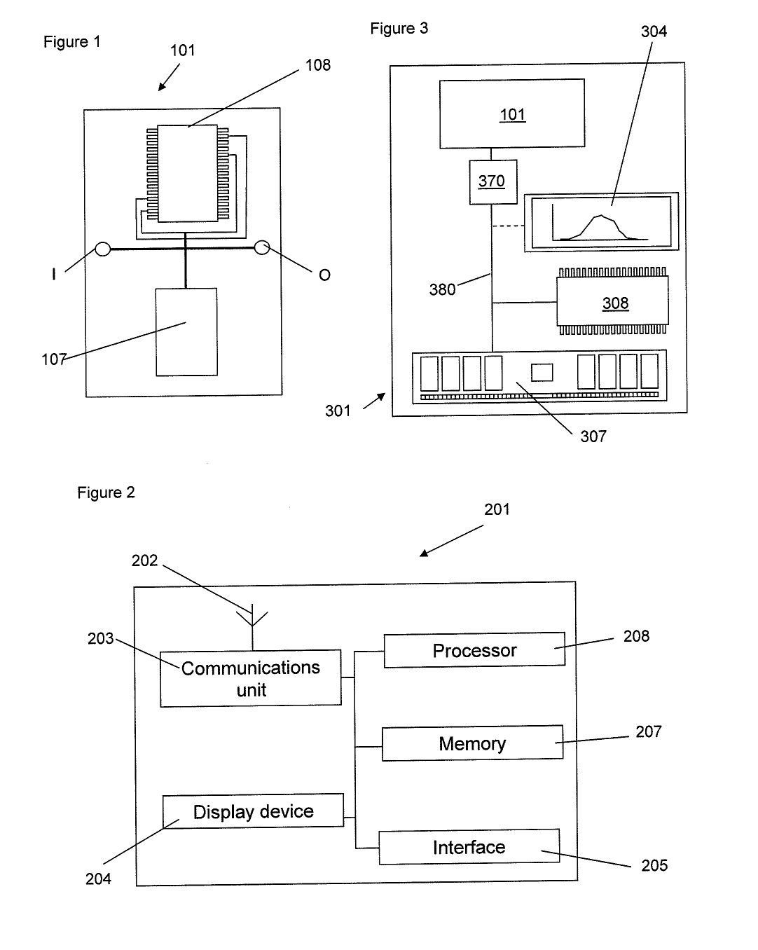

FIG. 1 shows an apparatus (101) comprising memory (107), a processor (108), input I and output O. In this embodiment only one processor and one memory are shown but it will be appreciated that other embodiments may utilise more than one processor and/or more than one memory (e.g. same or different processor/memory types).

In this embodiment the apparatus (101) is an Application Specific Integrated Circuit (ASIC) for a portable electronic device with a touch sensitive display. In other embodiments the apparatus (101) can be a module for such a device, or may be the device itself, wherein the processor (108) is a general purpose CPU of the device and the memory (107) is general purpose memory comprised by the device.

The input I allows for receipt of signalling to the apparatus (101) from further components, such as components of a portable electronic device (like a touch-sensitive display) or the like. The output O allows for onward provision of signalling from within the apparatus (101) to further components. In this embodiment the input I and output O are part of a connection bus that allows for connection of the apparatus (101) to further components.

The processor (108) is a general purpose processor dedicated to executing/processing information received via the input I in accordance with instructions stored in the form of computer program code on the memory (107). The output signalling generated by such operations from the processor (108) is provided onwards to further components via the output O.

The memory (107) (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor (108). The internal connections between the memory (107) and the processor (108) can be understood to, in one or more example embodiments, provide an active coupling between the processor (108) and the memory (107) to allow the processor (108) to access the computer program code stored on the memory (107).

In this example the input I, output O, processor (108) and memory (107) are all electrically connected to one another internally to allow for electrical communication between the respective components I, O, (108, 107). In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus (201) of a further example embodiment, such as a mobile phone. In other example embodiments, the apparatus (201) may comprise a module for a mobile phone (or PDA or audio/video player), and may just comprise a suitably configured memory (207) and processor (208).

The example embodiment of FIG. 2, in this case, comprises a display device (204) such as, for example, a Liquid Crystal Display (LCD) or touch-screen user interface. The apparatus (201) of FIG. 2 is configured such that it may receive, include, and/or otherwise access data. For example, this example embodiment (201) comprises a communications unit (203), such as a receiver, transmitter, and/or transceiver, in communication with an antenna (202) for connecting to a wireless network and/or a port (not shown) for accepting a physical connection to a network, such that data may be received via one or more types of networks. This example embodiment comprises a memory (207) that stores data, possibly after being received via antenna (202) or port or after being generated at the user interface (205). The processor (208) may receive data from the user interface (205), from the memory (207), or from the communication unit (203). It will be appreciated that, in certain example embodiments, the display device (204) may incorporate the user interface (205). Regardless of the origin of the data, these data may be outputted to a user of apparatus (201) via the display device (204), and/or any other output devices provided with apparatus. The processor (208) may also store the data for later use in the memory (207). The memory (207) may store computer program code and/or applications which may be used to instruct/enable the processor (208) to perform functions (e.g. read, write, delete, edit or process data).

FIG. 3 depicts a further example embodiment of an electronic device (301), such as a tablet personal computer, a portable electronic device, a portable telecommunications device, a server or a module for such a device, the device comprising the apparatus (101) of FIG. 1. The apparatus (101) can be provided as a module for device (301), or even as a processor/memory for the device (301) or a processor/memory for a module for such a device (301). The device (301) comprises a processor (308) and a storage medium (307), which are connected (e.g. electrically and/or wirelessly) by a data bus (380). This data bus (380) can provide an active coupling between the processor (308) and the storage medium (307) to allow the processor (308) to access the computer program code. It will be appreciated that the components (e.g. memory, processor) of the device/apparatus may be linked via cloud computing architecture. For example, the storage device may be a remote server accessed via the internet by the processor.

The apparatus (101) in FIG. 3 is connected (e.g. electrically and/or wirelessly) to an input/output interface (370) that receives the output from the apparatus (101) and transmits this to the device (301) via data bus (380). Interface (370) can be connected via the data bus (380) to a display (304) (touch-sensitive or otherwise) that provides information from the apparatus (101) to a user. Display (304) can be part of the device (301) or can be separate. The device (301) also comprises a processor (308) configured for general control of the apparatus (101) as well as the device (301) by providing signalling to, and receiving signalling from, other device components to manage their operation.

The storage medium (307) is configured to store computer code configured to perform, control or enable the operation of the apparatus (101). The storage medium (307) may be configured to store settings for the other device components. The processor (308) may access the storage medium (307) to retrieve the component settings in order to manage the operation of the other device components. The storage medium (307) may be a temporary storage medium such as a volatile random access memory. The storage medium (307) may also be a permanent storage medium such as a hard disk drive, a flash memory, a remote server (such as cloud storage) or a non-volatile random access memory. The storage medium (307) could be composed of different combinations of the same or different memory types.

The aforementioned apparatus (101, 201, 301) are configured to enable the determination of a volume characteristic and accordingly enable the selection of a particular function as previously mentioned.

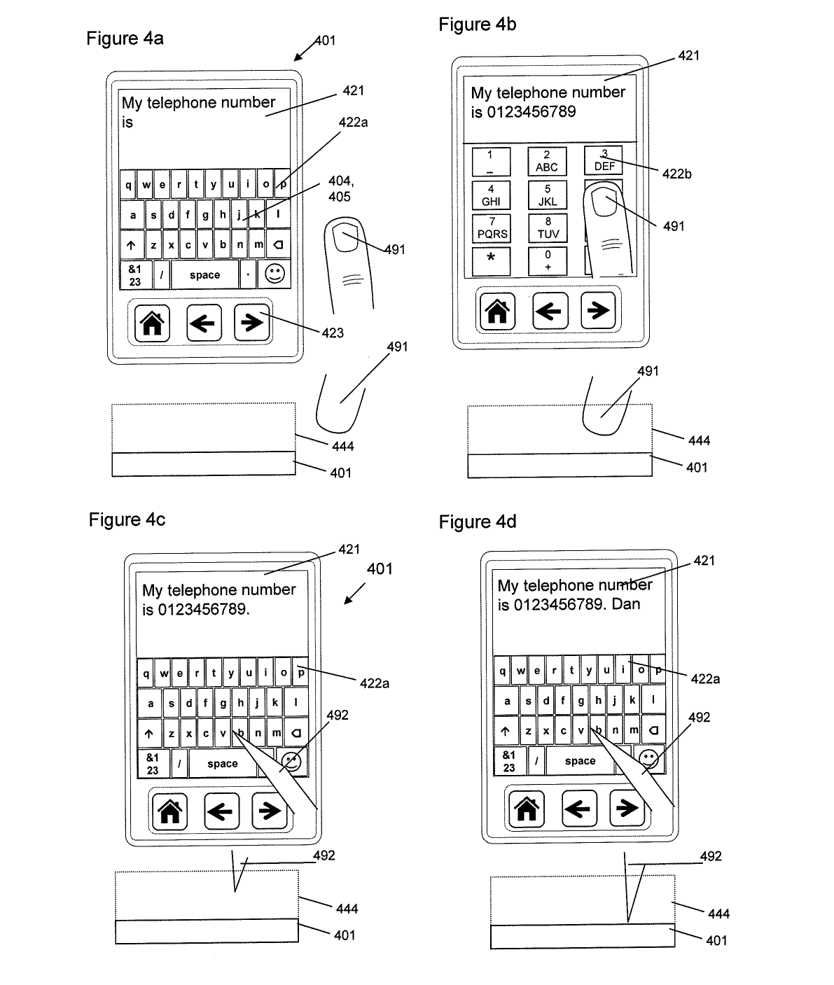

FIGS. 4a-4d depicts an example embodiment of the apparatus depicted in FIG. 2 comprising a portable electronic communications device (401), e.g. such as a mobile phone, with a user interface comprising a touch-screen user interface (405, 404), a memory (not shown), a processor (not shown) and an antenna (not shown) for transmitting and/or receiving data (e.g. emails, textual messages, phone calls, information corresponding to web pages).

In this case, the apparatus is configured to: enable the determination of a volume characteristic of at least one stylus within a detection range of a user interface for an electronic device; and according to the particular determined volume characteristic, enable the selection of a particular function of the electronic device selectable using the user interface, the particular function corresponding to the particular determined volumetric characteristic. In this case, styli with a small volume characteristic correspond with the function of providing a full QWERTY keyboard, and styli with a large volume characteristic correspond with the function of providing a reduced keyboard (with larger individual keys).

It will be appreciated that other volumetric characteristics may be used. For example, other example embodiments may use the change in volume as the at least one stylus is moved within the detection range of the user interface.

In the situation depicted in FIG. 4a, the user is using a messaging application to enter a textual message. When the messaging application is running, the electronic device is configured to display a message entry region (421), and a virtual keyboard user interface region (422a). In this case, the default mode is that the keyboard user interface region comprises a full QWERTY keyboard (422a). In this case, the user wishes to quickly enter a telephone number into the textual message and so, rather than use a mechanical stylus, he wishes to enter the information using his finger (491). In the situation depicted in FIG. 4a, the user's finger (491) is not within the detection range of the user interface.

FIG. 4b depicts the situation when the user has brought his finger stylus (491) within the detection range (444) of the user interface. When a stylus (in this case the user's finger (491)) is within the detection range (444) of the user interface, the apparatus/device (401) is configured to determine a volume characteristic of the at least one stylus within the detection range (444) of the user interface. In this case, the volumetric characteristic is a measure of the volumetric size of the stylus (491). It will be appreciated that other parameters may also be determined. For example, the apparatus/device may be configured to determine the distance of closest approach between the stylus and user interface, the angle of the stylus, the velocity of the stylus and/or the acceleration of the stylus. These aspects can be additionally considered in providing the particular mode—see later.

In this case, the apparatus/device is configured to model the approaching stylus by using a net which is deformed by the at least one stylus being within the detection range of the sensors (not shown). That is, when the sensor, which may be a capacitive sensor, detects an object (e.g. a stylus) approaching, the net is fit to match the data received from the sensor. This creates a three dimensional (3D) image (e.g. a topography) in which there may be features of possibly different heights and shapes. This three dimensional image can be used to determine, for example, the volumetric characteristic of the at least one stylus and/or the stylus type. For example, if a peak feature is curved but not sharp, it can be determined that the object is a finger and if the peak is sharp, it is easy to detect that the object is a pen or a stylus. Other example embodiments may be configured to determine the volumetric characteristic using other known non-contact techniques, for example.

In this case, the apparatus is configured such that a stylus with a small volume correspond to the function of providing a QWERTY keyboard, and that styli with a large volume correspond to the function of providing an ITU-T E.161 predictive text/numeric keyboard (as shown in FIG. 4b). That is, according to the particular determined volume characteristic, which in this case is a large determined volume characteristic, the apparatus/device is configured to enable the selection of the function of providing an ITU-T E.161 predictive text/numeric reduced keyboard (422b) to the user, the function corresponding to the determined volumetric characteristic. Providing a different keyboard may be considered to be an application mode of the messaging application. It will be appreciated that the keyboard may also be used to enter text into the message entry region (421) using predictive text and/or multi-touch input gestures.

In this case, after the user has completed entering the telephone number by providing touch gestures to the appropriate keys of the provided reduced keyboard (422b), he wishes to complete the message by entering alphabetic text. In this case, the user could enter text using the reduced keyboard (422b), but prefers to use a full QWERTY keyboard using a stylus (for example to reduce the number of keystrokes required). To enable the function of providing a full QWERTY keyboard, the user positions a pointed mechanical stylus (492) (having a small volume characteristic) within the detection range of the user interface (as shown in FIG. 4c). In response to detecting the mechanical stylus (491) within the detection range of the user interface, the apparatus/device is configured to determine a volume characteristic of the at least one stylus within the detection range of the user interface for the electronic device. In this example, the apparatus determines that the at least one stylus has a relatively small volume characteristic. In this case, according to the small determined volume characteristic, the apparatus/device is configured to enable the selection of a function corresponding to the small determined volume characteristic. The ITU-T E.161 keyboard is provided prior to actual touch of the user interface. That is, it is provided as soon as the volumetric characteristic is determined within the detection range, prior to touch. In this case, the function corresponding to the small determined volume characteristic is the provision of a full QWERTY keyboard (422a).

FIG. 4d depicts the situation when the user has completed the message by entering text by selecting keys using successive touch gestures.

In this case, the determined volume of the at least one stylus is related to the key size of the corresponding keyboard. That is, if a user wishes to use a larger stylus (such as a finger), the apparatus/device is configured to enable provision of a keyboard with correspondingly larger and fewer keys. Likewise, if the user wishes to use a smaller stylus (such as a pointed mechanical stylus), the apparatus/device is configured to enable provision of a keyboard with a larger number of keys which are smaller.

It will be appreciated that other example embodiments may be configured to adjust the size of the user interface elements in response to the determined volumetric characteristic. For example, an example embodiment may be configured to enable the same QWERTY keyboard to be enlarged in response to determining that the user is using a larger stylus (i.e. having a larger volumetric characteristic). Similarly, the position of a pop-up may be dependent on the size and shape of the stylus. For example, if the stylus were determined to be large the pop-up may be enabled to be displayed at a greater distance from the centre of a subsequent touch input. Likewise, the position of a pop-up may be based on the angle of the stylus (or distance of closest approach between the stylus and user interface), for example, so that the pop-up is not obscured by the stylus.

It will be appreciated that other example embodiments may be configured to enable selection of a particular function based on the speed, acceleration and/or velocity of the stylus. For example, if a user was reading a book using an e-reader application, a swipe gesture below a certain velocity, speed and/or acceleration may enable the function of turning the page, whereas a swipe gesture exceeding a certain velocity, speed and/or acceleration threshold may enable the function of skipping to the next chapter of the book.

It will be appreciated that other example embodiments may be configured to change the mode of the device/application based on the type of stylus. For example, an embodiment may be configured to change the mode of a device to a voice only mode if it was determined using the volumetric characteristic that the stylus was a gloved hand/finger. This may be advantageous for embodiments not configured to recognise touch inputs provided with a gloved hand/finger (e.g. a capacitive touch sensitive screen). It will be appreciated that embodiments may be configured to enable functionality of the device according to the finger styli holding the device. For example, if gloved fingers were detected within the detection range of the user interface, the device may be configured to enter a voice only mode. This may allow the mode to be determined by holding the device with gloved fingers rather than requiring any specific selection input.

In order to detect if a user is wearing gloves, an embodiment may be configured to determine a volume characteristic of one or more finger styli holding the device within the detection range of the user interface. The embodiment may be configured to determine that a user is wearing gloves by determining that one or more finger styli within the detection range is shaped (and/or positioned) so as to grip the device (using a shape volumetric characteristic), but that the finger styli are not in contact with the device (e.g. because the gloves prevent the users finger being in direct contact with the user interface but are not detected by the user interface).

It will be appreciated that if a user is holding the electronic device using a gloved hand, it may be inferred that the user's other hand (e.g. which may be used to interact with the user interface to operate the device) is also gloved. In addition, it will be appreciated that if the finger styli holding the device are determined to be gloved, it may be inferred that the thumb of the same hand (e.g. which may be used to interact with the user interface to operate the device) is also gloved. That is, if the volumetric characteristic of the styli is consistent with being the thumb of the hand which is holding the device, and the device/apparatus has determined that the finger styli of the hand which is holding the device are gloved, the apparatus/device may be configured to recognise that the thumb may also be gloved. This may allow the device/apparatus to change the detection mode of the user interface to a glove detection mode (e.g. wherein the thumb does not have to contact the screen, but come within a determined threshold distance, to select a user interface element).

A further embodiment may be configured to enable the user to write on the screen if the stylus was determined to be a mechanical stylus (e.g. for hand writing recognition) using the volumetric characteristic, and/or enable the provision of a keyboard if the stylus was determined to be a finger using the volumetric characteristic.

Likewise, the shape of the at least one stylus may be taken into account when determining the mode. For example, when a user is using a mechanical stylus, the apparatus/device may be configured not to process inputs provided using a finger. This may help prevent accidental gestures/inputs being entered.

In other example embodiments, the change of volumetric shape and size may be used to determine the particular function which is enabled. For example, an embodiment may be configured to recognise different users performing the gesture of putting a first finger stylus within the detection range of the user interface followed by a second finger stylus. That is, although different users may have different absolute finger stylus sizes, the relative sizes of each user's first and second fingers may be the same. My measuring the relative changes in volumetric size as the gesture is performed, the apparatus/device may be able to recognise this gesture and enable the corresponding function.

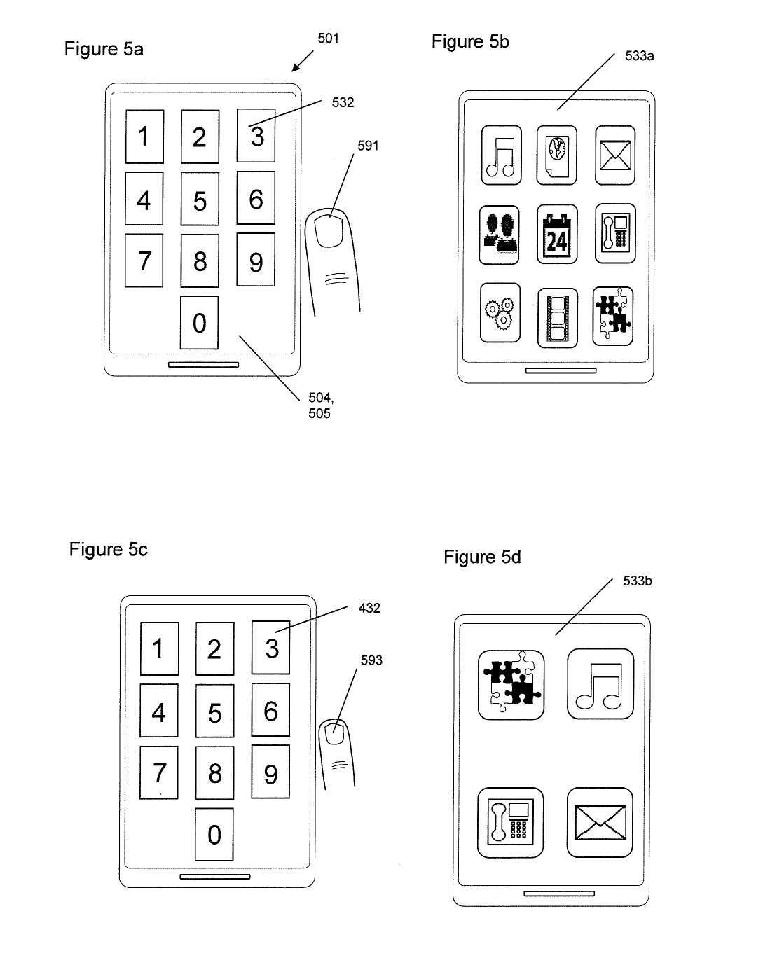

FIGS. 5a-5d depicts an further example embodiment comprising a portable electronic communications device (401), e.g. such as a mobile phone, with a user interface comprising a touch-screen user interface (405, 404), a memory (not shown), a processor (not shown) and an antenna (not shown) for transmitting and/or receiving data (e.g. emails, textual messages, phone calls, information corresponding to web pages).

In this case, the apparatus is configured to: enable the determination of a volume characteristic of at least one stylus within a detection range of a user interface for an electronic device; and according to the particular determined volume characteristic, enable the selection of a particular function of the electronic device selectable using the user interface, the particular function corresponding to the particular determined volumetric characteristic.

In the situation depicted in FIG. 5a, the electronic device is in a locked mode. That is, the functionality of the user interface is deactivated with the exception of enabling the unlocking of the device (and/or accepting an incoming call). In this case, the device is configured to display a numeric keypad (532) which is configured to enable the user to enter a personal identification number using a three-dimensional pattern to unlock the device. The pattern is three dimensional in that the user interface is configured to distinguish the position of the stylus with respect to the two-dimensional plane of the touch screen user interface and also the distance of the stylus from the plane of the touch screen user interface. For example, the three dimensional pattern may comprise a touch gesture with the ‘1’ key user interface element followed by a hover gesture over the ‘4’ and ‘5’ key user interface element (the hover gesture being within the detection range of the user interface, but not touching the user interface) followed by a touch gesture with the ‘8’ user interface element. By using a three dimensional pattern as a unlock key, the number of available patterns are increased compared with a standard selection sequence of keys (e.g. touch inputs with the ‘1’, ‘4’, ‘5’, and ‘8’ key user interface elements). In this case the same three-dimensional pattern is the same for all users of the device. That is, it is a general unlock three-dimensional pattern, rather than being user-specific. It will be appreciated that for other example embodiments, each user may have a different unlock three-dimensional pattern which do not necessarily need to comprise physical touching of the user interface.

In this case, the apparatus is configured to determine a volumetric characteristic of the at least one stylus within a detection range of the user interface as the at least one stylus is tracing out the three dimensional pattern to unlock the device. In this case, the volume characteristic of the at least one stylus corresponds to the enabling selection of a particular function of the electronic device, wherein the particular function comprises enabling a particular device operating mode of a plurality of device operating modes associated with the electronic device. In this case, each device operating mode is associated with an age category (e.g. a child mode and an adult mode), and the enabled function is specific for the age category.

In the situation depicted in FIG. 5a, an adult (with a relatively large finger stylus (491)) is entering the predetermined (e.g. user-defined) three-dimensional unlocking pattern. As the adult is performing the three-dimensional unlocking pattern, the device/apparatus is configured to determine a volumetric characteristic of the at least one stylus (which in this case is the adult's finger). In this case, styli with a volumetric characteristic greater than a threshold volume value are recognised as a being that of an adult. It will be appreciated that other example embodiments may use different volumetric characteristic criteria to determine whether or not the selection of a particular function is enabled. The particular function corresponding to the determined adult volumetric characteristic is opening the device in an adult mode. In an adult mode, the home screen (533a) is configured to make available the full suite of applications stored on the electronic device. As shown in FIG. 5b, the available applications include; a music application; a web-browser application; an email application; a messaging application, a calendar application; a telephone application; a settings application; a film application; and a games application.

In the situation depicted in FIG. 5c, a child (with a small finger stylus (493)) is entering the predetermined (e.g. user-defined) three-dimensional unlocking pattern. As the child is performing the three-dimensional unlocking pattern, the device/apparatus is configured to determine a volumetric characteristic of the at least one stylus (which in this case is the child's finger). In this case, styli with a volumetric characteristic less than a threshold volume value are recognised as being that of a child. The particular function corresponding to the determined adult volumetric characteristic is opening the device in a child mode. In a child mode, the home screen is configured to make available a subset of applications stored on the electronic device. As shown in FIG. 5d, the available applications include a music application, an email application, a telephone application, and a games application.

In this case, the three-dimensional unlocking pattern is the same for all users, and the determined volumetric characteristic influences the unlocked mode of the device (i.e. whether it is an adult or a child mode). It will be appreciated that whether the device is in a child mode or an adult mode may affect other behaviours of the device (e.g. user-defined preferences).

It will be appreciated that other example embodiments may be such that the volume characteristic is configured to provide authentication information, the authentication information configured to enable the device to authenticate a particular user such that the particular user is allowed to access particular functions specific to the particular user. For example, each user may have a unique three-dimensional unlocking pattern, which is configured to unlock the device only when the determined volume characteristic also corresponds to the particular user. That is, if another person with a different size of finger were to discover the three-dimensional unlocking pattern of the user, they could not use the discovered unlocking pattern to unlock the device, as the apparatus/device would determine that the person entering the pattern was a different user as the determined volumetric characteristic would be different.

In the above embodiment, the volumetric characteristic is used to determine which device operating mode of a plurality of device operating modes is enabled. It will be appreciated that other device operating modes may be available. For example a device operating mode may be background device operating mode (e.g. wherein the user interface is not responsive to user input, other than to change mode, but processing may still occur), a safe device operating mode (e.g. wherein functions, applications, and/or capabilities are restricted such as an airplane mode where transmission/receiving functions are suppressed), an edit device operating mode (e.g. wherein data stored on the device can be edited), a sleep device operating mode (e.g. wherein the resources made available to the device is reduced in order to, for example, extend battery life), an administrator mode (e.g. wherein a particular user or users have access to settings which are otherwise not available such as a parent mode or an adult mode), a child mode (e.g. wherein access to settings and/or content is age restricted), a read-only device operating mode (e.g. wherein data stored on the device is accessible to read but not to write), a user-defined device operating mode (e.g. wherein a user has saved a set of preferences dictating the functionality/behaviour of the device), or a user-specific device operating mode (e.g. wherein a particular user is associated with a particular set of preferences/functionality).

It will be appreciated that enabling a particular device operating mode may comprise changing from a first mode of a first type (e.g. from an administrator mode) to a second mode of a second different type (e.g. from a child mode). It will be appreciated that enabling a particular device operating mode may comprise changing from a first mode of a first type (e.g. from a user-defined mode associated with a first user) to a second mode of the same first type (e.g. to a user-defined mode associated with a second user).

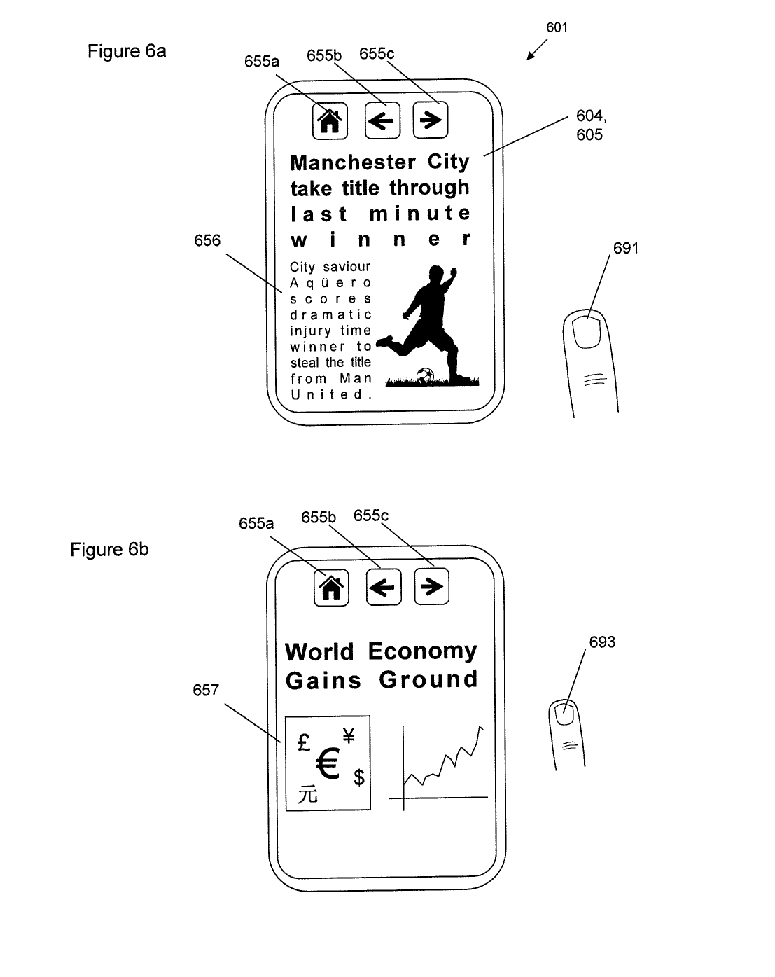

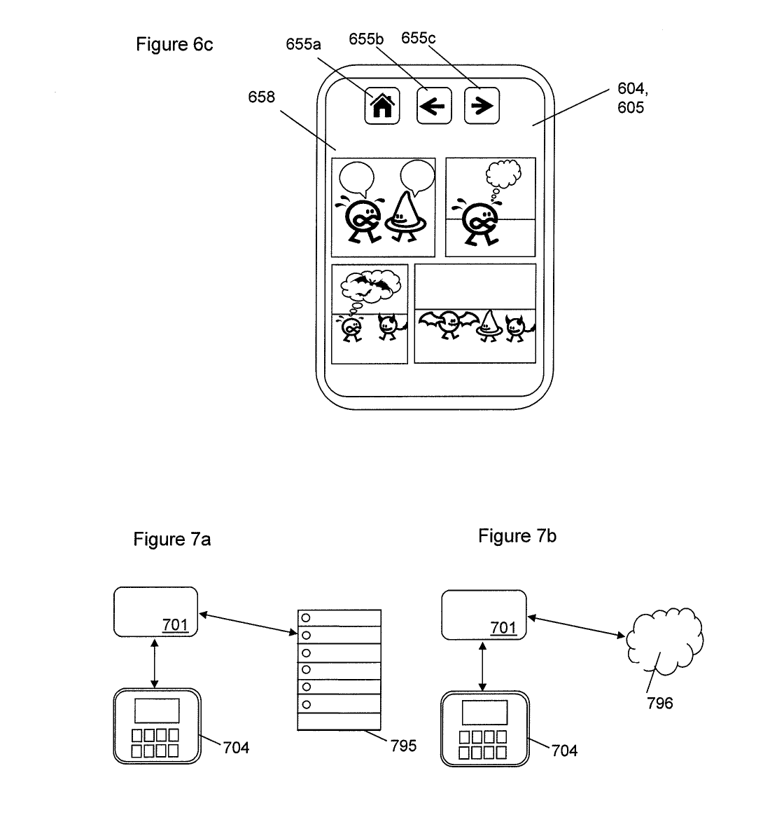

FIGS. 6a-6c depicts an example embodiment of the apparatus depicted in FIG. 2 comprising a portable electronic device (601), e.g. such as a personal digital assistant or tablet computer, with a user interface comprising a touch-screen user interface (605, 604), a memory (not shown), a processor (not shown) and an antenna (not shown) for transmitting and/or receiving data (e.g. emails, textual messages, phone calls, information corresponding to web pages). In this case, the apparatus is configured to: enable the determination of a volume characteristic of at least one stylus within a detection range of a user interface for an electronic device; and according to the particular determined volume characteristic, enable the selection of a particular function of the electronic device selectable using the user interface, the particular function corresponding to the particular determined volumetric characteristic.

In the situation depicted in FIG. 4a, the user is using a web browser application to navigate the web. In this case, when the web browser application is running, the user interface is configured to display a navigation icon region, comprising a number of navigation icons (655a-c), and a content region configured to display the website. In this case, the navigations icons comprising a home page icon (655a), configured to allow the user to navigate to a user-defined home page, and forward (655b) and back (655c) navigations buttons configured to allow the user to navigate to web pages in the order that they had been viewed. In this example embodiment, the home page icon user interface element (655a) is associated with a plurality of functions, wherein each of the functions corresponds to a particular volume characteristic. That is, a first volume characteristic is associated with a first user and corresponds to the function of opening a news home page. A second volume characteristic is associated with a second user and corresponds to the function of opening a cartoon strip home page.

In the situation depicted in FIG. 6a, the first user (e.g. a father) is viewing a sports web page. The first user wishes to navigate to his home page by selecting the home page icon user interface element (655a). As the user is bringing his finger stylus (691) towards the home page user interface element (655a), the first user stylus (691) comes within the detection range of the user interface. In response to the stylus being within the user interface detection range, the apparatus/device is configured to determine a volume characteristic of the stylus within the detection range of the user interface. In this case, the device is configured to determine the volume of the stylus, the shape of the stylus, and the trajectory of the stylus. The volume and the shape of the stylus are used by the device to recognise which user is interacting with the device. The trajectory is used to determine which user interface element might be selected by the user (e.g. to ensure more accurate selection of the user interface element). In this case, the volume characteristic and stylus angle are determined to correspond to the first (father) user.

Based on the determined first user volume characteristic, the device/apparatus is configured to enable the selection of the function of navigating to the news home page. In this case, selection is performed by the user providing a touch input to the corresponding user interface element. After selection of the home page user interface, the particular function is performed and the news home page (657) is displayed (as depicted in FIG. 6b). In this case, the apparatus is configured such that the volume characteristic is determined prior to the stylus touching the user interface; and the selection of a particular function is performed in response to a touch input provided by the stylus touching the user interface.

In FIG. 6b, the user has passed the device to his young son (the second user). The son wishes to navigate to his second user home page and by selecting the home page icon user interface element. As the second (son) user is bringing his finger stylus (693) towards the home page user interface element (655a), the second user stylus (693) comes within the detection range of the user interface. When the second user finger stylus is within the user interface detection range, the apparatus/device is configured to determine a volume characteristic of the stylus within the detection range of the user interface. In this case, the device is configured to determine the volume of the at least one stylus, the shape of the at least one stylus, and the trajectory of the at least one stylus. The volume and the shape of the at least one stylus are used by the device to recognise which user is interacting with the device. The trajectory is used to determine which user interface element might be selected by the user. In this case, the volume characteristic and stylus angle are determined to correspond to the second (son) user.

Based on the determined second user volume characteristic, the device/apparatus is configured to enable the selection of the function of navigating to the cartoon strip home page. In this case, selection is performed by the user providing a touch input to the home page user interface element (455a). After selection of the home page user interface, the particular function is performed and the cartoon strip home page (658) is displayed (as depicted in FIG. 6c).

It will be appreciated that other example embodiments may be configured to enter a particular mode when it is determined using volumetric characteristics that a particular user, or a user of a particular category, has begun to interact with the device. For example, an embodiment may be configured to enter a child mode when the finger of a young person (with a small finger/hand) is detected within the detection range of the user interface.

In the above embodiment, the volumetric characteristic is used to determine which application operating mode of a plurality of device operating modes is enabled. It will be appreciated that other application operating modes may be available. For example an application operating mode may be background application operating mode (e.g. wherein the application is not visible on the display because it is minimised or at least partially concealed behind another application), a safe application operating mode (e.g. wherein functions, applications, and/or capabilities are restricted such as an roaming telephone application mode wherein extra confirmation is required before a telephone call is made), an edit application operating mode (e.g. wherein data can be edited using the application), a sleep application operating mode (e.g. wherein device resources allocated to the application is reduced), an administrator application mode (e.g. wherein a particular user or users have access to settings which are otherwise not available such as a parent application mode or an adult mode), a child application mode (e.g. wherein access to settings and/or content is age restricted), a read-only application operating mode (e.g. wherein data can be read by the application but not edited), a user-defined application operating mode (e.g. wherein a user has saved a set of preferences dictating the functionality/behaviour of the application), or a user-specific device operating mode (e.g. wherein a particular user is associated with a particular set of preferences/functionality).

It will be appreciated that enabling a particular application operating mode may comprise changing from a first mode of a first type (e.g. from an administrator mode) to a second mode of a second different type (e.g. from a child mode). It will be appreciated that enabling a particular application operating mode may comprise changing from a first mode of a first type (e.g. from a user-defined mode associated with a first user) to a second mode of the same first type (e.g. to a user-defined mode associated with a second user).

Advantages of the enabling functionality according to a determined volumetric characteristic may include that the user interface can respond differently to different users, or different types of users. This may mean that the user interface may not require additional user interface elements to implement user preferences. This may allow a more intuitive and less cluttered user interface.

FIG. 7a shows that an example embodiment of an apparatus in communication with a remote server. FIG. 7b shows that an example embodiment of an apparatus in communication with a “cloud” for cloud computing. In FIGS. 7a and 7b, apparatus (701) (which may be apparatus (101), (201) or (301)) is in communication with a display (704). Of course, the apparatus (701) and display (704) may form part of the same apparatus/device, although they may be separate as shown in the figures. The apparatus (701) is also in communication with a remote computing element. Such communication may be via a communications unit, for example. FIG. 7a shows the remote computing element to be a remote server (795), with which the apparatus may be in wired or wireless communication (e.g. via the internet, Bluetooth, a USB connection, or any other suitable connection as known to one skilled in the art). In FIG. 7b, the apparatus (701) is in communication with a remote cloud (796) (which may, for example, by the Internet, or a system of remote computers configured for cloud computing). It may be that the character string and/or at least some user applications are stored/run at the remote computing element (795), (796) and accessed by the apparatus (701) for display (704). The user applications and user event content need not all be stored at the same location. Some or all of the user applications and/or user content may be stored at the apparatus (101), (201), (301), (701). The functionality of volume characteristic determination and the provision of a particular functional mode may be provided at the respective remote computing element (795), (796). The apparatus (701) may actually form part of the remote sever (795) or remote cloud (796). In such embodiments, the enablement of the volumetric characteristic and the provision of the particular function may be conducted by the server or in conjunction with use of the server/cloud.

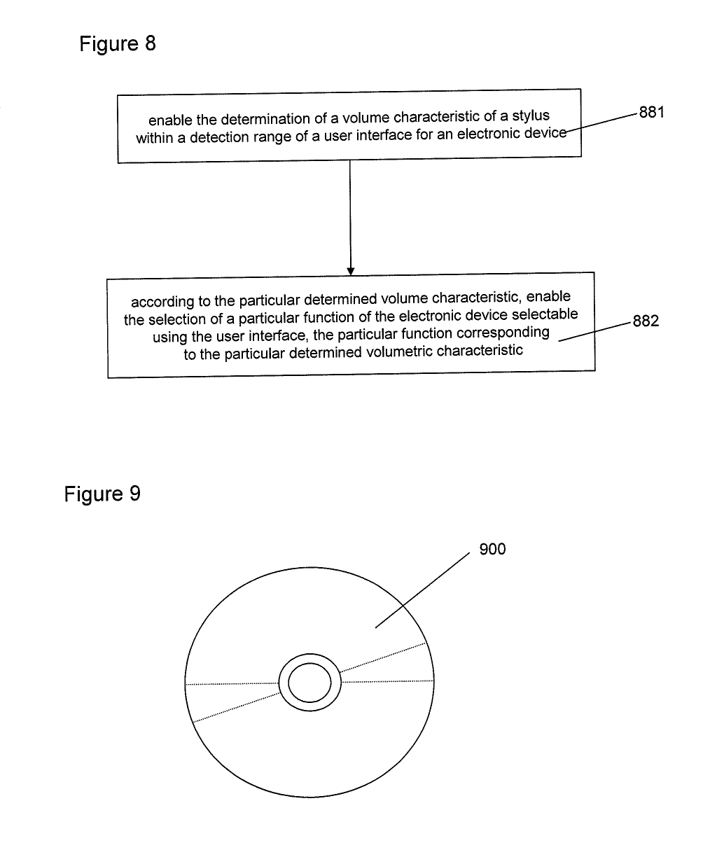

FIG. 8 illustrates the process flow according to an example embodiment of the present disclosure. The process comprises enabling (881) the determination of a volume characteristic of at least one stylus within a detection range of a user interface for an electronic device; and, according to the particular determined volume characteristic, enabling (882) the selection of a particular function of the electronic device selectable using the user interface, the particular function corresponding to the particular determined volumetric characteristic. The respective functionality (881) and (882) may be performed by the same apparatus or different apparatus.

FIG. 9 illustrates schematically a computer/processor readable medium (900) providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
according to a particular determined volume characteristic of at least one stylus within a detection range of a user interface for an electronic device, enable the selection of a particular function of the electronic device selectable using the user interface, the particular function corresponding to the particular determined volumetric characteristic.

2. The apparatus of claim 1, wherein the volumetric characteristic is one or more of the volumetric shape, volumetric size, or changes in the volumetric shape and volumetric size of the at least one stylus within the detection range.

3. The apparatus of claim 1, wherein the particular function comprises opening an application in a particular application operating mode of a plurality of application operating modes associated with the application.

4. The apparatus of claim 1, wherein the particular function comprises enabling a particular device operating mode of a plurality of device operating modes associated with the electronic device.

5. The apparatus of claim 3, wherein a said application operating mode is a background application operating mode, a safe application operating mode, an edit application operating mode, a sleep application operating mode, a parent mode, a child mode, an adult mode, a read-only application operating mode, a user-defined application operating mode, or a user-specific application operating mode.

6. The apparatus of claim 4, wherein a said device operating mode is a background device operating mode, a safe device operating mode, an edit device operating mode, a sleep device operating mode, a parent mode, a child mode, an adult mode, a read-only device operating mode, a user-defined device operating mode, or a user-specific device operating mode.

7. The apparatus of claim 1, wherein the particular function is associated with actuation of a particular user interface element of the user interface.

8. The apparatus of claim 1, wherein the particular function is associated with actuation of the user interface per se.

9. The apparatus of claim 1, wherein the selection of the particular function is enabled based on further considering one or more of:
angle of a said stylus;
velocity of a said stylus;
the trajectory of a said stylus;
speed of a said stylus;
acceleration of a said stylus;
a user interface element associated with a stylus position; and
a detected gesture input provided using a said stylus.

10. The apparatus of claim 1, wherein a said user input comprises:
a non-touch gesture;
a multi-touch gesture;
a tap gesture;
a drag gesture;
a scroll input;
a three dimensional pattern gesture;
a two dimensional pattern gesture;
a key press; and
a button press.

11. The apparatus of claim 1, wherein a volume characteristic is associated with a particular user, the enabled function being associated with the particular user.

12. The apparatus of claim 1, wherein the volume characteristic is configured to provide authentication information, the authentication information configured to enable the device to authenticate a particular user such that the particular user is allowed to access particular functions which are specific to the particular user.

13. The apparatus of claim 1, wherein the volume characteristic is associated with an age category, the enabled function corresponding to the age category.

14. The apparatus of claim 1, wherein the volume characteristic is associated with a stylus type, the enabled function corresponding to the stylus type.

15. The apparatus of claim 1, wherein a said stylus type comprises:
a finger;
a gloved finger;
a hand;
a gloved hand;
a stylus tool;
a pen;
a pencil;
a mechanical stylus;
a substantially tubular object; and
a substantially cylindrical object.

16. The apparatus of claim 1, wherein
the volume characteristic is determined prior to the at least one stylus touching the user interface; and
the selection of a particular function is performed in response to a touch input provided by the at least one stylus touching the user interface.

17. The apparatus of claim 1, wherein the user interface comprises a combination of one or more of a touchpad, and a touch-screen.

18. The apparatus of claim 1, wherein the electronic device is a portable electronic device, a laptop computer, a desktop computer, a mobile phone, a Smartphone, a monitor, a personal digital assistant or a digital camera, or a module for the same.

19. A method comprising:
according to a particular determined volume characteristic of at least one stylus within a detection range of a user interface for an electronic device, enabling the selection of a particular function of the electronic device selectable using the user interface, the particular function corresponding to the particular determined volumetric characteristic.

20. A computer program, the computer program comprising code configured to:
according to a particular determined volume characteristic of at least one stylus within a detection range of a user interface for an electronic device, enable the selection of a particular function of the electronic device selectable using the user interface, the particular function corresponding to the particular determined volumetric characteristic.
